(19) United States
(12) Patent Application Publication
(10) Pub. No.: US 2016/0170461 A1
(43) Pub. Date: Jun. 16, 2016

(54) PROVISIONING POWER FOR NON-POE DEVICE

(71) Applicants: Allied Telesis Holdings Kabushiki Kaisha, Tokyo (JP); ALLIED TELESIS, INC., Bothell, WA (US)

(72) Inventor: Daniel Stellick, Geneva, IL (US)

(21) Appl. No.: 14/565,996

(22) Filed: Dec. 10, 2014

(51) Int. Cl. G06F 1/26; H04L 12/10; G06F 1/28

(52) U.S. Cl. CPC G06F 1/266; G06F 1/28; H04L 12/10

(57) ABSTRACT

Some embodiments provide a device that includes a connection manager module and a power manager module. The connection manager module may be configured to establish a connection with a power sourcing power over Ethernet (PoE) device. The connection manager module may be further configured to draw power from the power sourcing PoE device over the connection. The power manager module may be configured to modify the power drawn from the power sourcing PoE device. The power manager module may be further configured to provide the modified power to a non-PoE device.

### BACKGROUND

Power over Ethernet (PoE) technologies facilitate communication of data among PoE-compatible devices as well as provide power for such devices. These technologies eliminate the need for external power sources (e.g., AC adapters), reduce the amount of cabling needed to deploy PoE-compatible devices, reduce costs, etc.

Many electronic devices today are not PoE-compatible devices. For instance, many smartphone devices, tablet computing devices, laptop computing devices, etc., are not PoE-compatible devices. Such devices are battery-powered that once depleted require charging or replacement in order to continue operating.

### SUMMARY

Accordingly, a need has arisen to provide a device configured to emulate a PoE-capable device so that the device may receive power from a power-providing PoE device and, in turn, provide such power to a non-PoE-capable device. In this manner, a non-PoE device may utilize the power-provisioning feature of a power-providing PoE device to power the non-PoE-capable device and/or charge batteries of the non-PoE device.

In some embodiments, a device includes a connection manager module that is configured to establish a connection with a power sourcing power over Ethernet (PoE) device. The connection manager module may be further configured to draw power from the power sourcing PoE device over the connection. The device also includes a power manager module that is configured to modify the power drawn from the power sourcing PoE device. The power manager module may be further configured to provide the modified power to a non-PoE device.

In some embodiments, the device further includes an Ethernet interface through which the connection manager establishes the connection with the power sourcing PoE device and draws power from the power sourcing PoE device. The device may further include, in some embodiments, a power provisioning interface through which the power manager provides the modified power to the non-PoE device. It is appreciated that the power provisioning interface may be a universal serial bus (USB) interface.

In some embodiments, the connection manager module may be further configured to provide to the power sourcing PoE device identification information that identifies the device as a PoE-capable device. The power manager module may be further configured to convert the power from a first voltage to a second voltage, in some embodiments. It is appreciated that the non-PoE device may be a mobile device.

In some embodiments, a machine-readable storage medium has machine executable instructions stored on it that, if executed by a device, cause the device to perform a method. The method draws power from a power sourcing power over Ethernet (PoE) device over a connection. The method further modifies the power drawn from the power sourcing PoE. The method also provides the modified power to a non-PoE device.

In some embodiments, the modified power may power the non-PoE device. The modified power may, in some embodiments, charge a battery of the non-PoE device. It is appreciated that the drawing of the power may be via an Ethernet interface.

In some embodiments, the method may provide identification information that identifies the device as a PoE-capable device to the power sourcing PoE device. The providing may include applying a predetermined resistance across transmit and receive pairs of the Ethernet interface. The connection with the power sourcing PoE device may be established in response to the providing the identification information to the power sourcing PoE device.

In some embodiments, a method that draws power from a power sourcing power over Ethernet (PoE) device over a connection. The method further modifies the power drawn from the power sourcing PoE device. The method also provides the modified power to a non-PoE device.

In some embodiments, the modifying of the power drawn from the power sourcing PoE device includes converting the power from a first voltage to a second voltage. It is appreciated that the second voltage may be 5 volts. It is also appreciated that the second voltage may be 12 volts.

In some embodiments, the providing of the modified power to the non-PoE device includes providing the modified power through a power receiving interface of the non-PoE device. It is appreciated that the power receiving interface may be a universal serial bus (USB) interface.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIG. 1 shows a system for providing power from a power sourcing PoE device to a non-PoE device in accordance with some embodiments.

FIG. 2 shows an architectural block diagram of a device for charging non-PoE devices in accordance with some embodiments.

FIG. 3 shows an exemplary flow diagram for providing power to a non-PoE device in accordance with some embodiments.

### DETAILED DESCRIPTION

Reference will now be made in detail to various embodiments, examples of which are illustrated in the accompanying drawings. While various embodiments are described herein, it will be understood that these various embodiments are not intended to limit the scope of the embodiments. On the contrary, the embodiments are intended to cover alternatives, modifications, and equivalents, which may be included within the scope of the embodiments as construed according to the appended Claims. Furthermore, in the following detailed description of various embodiments, numerous specific details are set forth in order to provide a thorough understanding of the concept. However, it will be evident to one of ordinary skill in the art that the concept may be practiced without these specific details. In other instances, well known methods, procedures, components, and circuits have not been described in detail as not to unnecessarily obscure aspects of the concept and embodiments.

Some portions of the detailed descriptions that follow are presented in terms of procedures, logic blocks, processing, and other symbolic representations of operations on data bits within a computer system or computing device memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “detecting,” “providing,” “drawing,” “modifying,” “converting,” “receiving,” “sending,” “establishing,” “maintaining,” or the like, refer to actions and processes of a computer system or similar electronic computing device or processor. The computer system or similar electronic computing device manipulates and transforms data represented as physical (electronic) quantities within the computer system or similar electronic computing device memories, registers or other such information storage, transmission or display devices.

It is appreciated that present systems and methods can be implemented in a variety of architectures and configurations. For example, present systems and methods can be implemented as part of a distributed computing environment, a cloud computing environment, a client-server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Embodiments described herein are directed to PoE emulating devices configured to emulate a PoE-capable device (also referred to in the present application as a PoE device). Accordingly, the PoE emulating devices may receive power from a power-providing PoE device and, in turn, provide such power to a non-PoE-capable device (also referred to in the present application as a non-PoE device) when coupled thereto. This allows a non-PoE device to utilize the power-provisioning feature of a power-providing PoE device in order to power the non-PoE device for use and/or charging.

In some embodiments, the PoE emulating device may establish and maintain a connection (e.g., a PoE link) with a power sourcing PoE device. The PoE emulating device may draw power from the power sourcing PoE though the connection. In some embodiments, the PoE emulating device may modify characteristics of the power (e.g., modify voltage, current, etc.) drawn from the power sourcing PoE device. The modified power may be output to a non-PoE device.

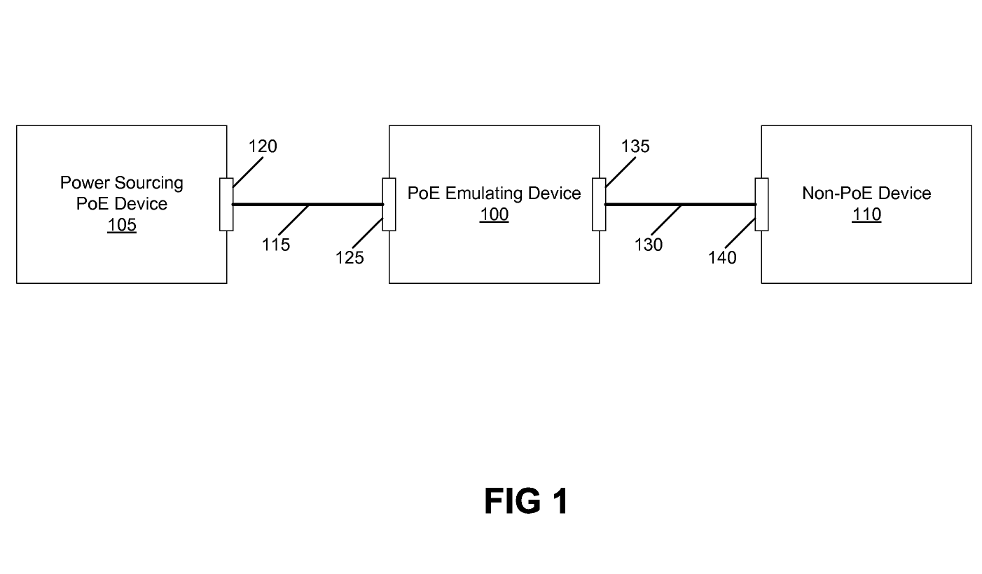

Referring now to FIG. 1, a system for providing power from a power sourcing PoE device to a non-PoE device is shown in accordance with some embodiments. As illustrated, FIG. 1 includes a PoE emulating device 100, a power sourcing PoE device 105, and a non-PoE device 110. Power sourcing PoE device 105 is a device configured to use PoE technologies to provide power over Ethernet cabling to PoE-capable devices. In some embodiments, the power sourcing PoE device 105 may be a network switch, an external PoE injector, etc., to name a few. It is appreciated that power sourcing PoE device 105 may be an 802.3af, 802.3at, etc., compliant power sourcing equipment (PSE).

Non-PoE device 110 is a device that does not have PoE capabilities. In some embodiments, a device that does not have PoE capabilities lacks the ability to draw power from a power sourcing PoE device (but may have the ability to communicate data through the power sourcing PoE device). A device that does not have PoE capabilities, in some embodiments, is not compliant with 802.3af and 802.3at standards. It is appreciated that non-PoE device 110 may be a smartphone, a personal digital assistant (PDA), a tablet computing device, a navigation device, a laptop computing device, a networking device, a wearable device, a digital camera, a video camera, or any other type of electronic and/or mobile device.

In this example, PoE emulating device 100 is configured to emulate a PoE device when coupled to non-PoE device 110. Thus, from the perspective of power sourcing PoE device 105, PoE emulating device 100 appears as a PoE device. This way, PoE emulating device 100 may draw power from power sourcing PoE device 105 and, in turn, provide the power to non-PoE device 110. In other words, PoE emulating device 100 acts as an intermediary device that facilitates provisioning of power from power sourcing PoE device 105 to non-PoE device 110.

As shown, power sourcing PoE device 105 is communicatively coupled to PoE emulating device 100 via Ethernet cable 115. Specifically, Ethernet cable 115 connects to Ethernet port 120 of power sourcing PoE device 105 and Ethernet port 125 of PoE emulating device 100. In addition, PoE emulating device 100 is communicatively coupled to non-PoE device 110 through connection 130 and interfaces 130 and 135. In some embodiments, connection 130, interface 135 of PoE emulating device 100, and interface 140 of non-PoE device 110 may be implemented using a technology for transporting electricity between PoE emulating device 100 and non-PoE device 110. For instance, connection 130 and interfaces 135 and 140 may be implemented using a wired technology (e.g., a universal serial bus (USB) cable), a wireless technology (e.g., inductive charging), etc.

The above-described FIG. 1 shows a PoE emulating device and a non-PoE device as separate devices. It is appreciated that the PoE emulating device may be a detachable and removable device that can be coupled to the non-PoE device. In addition, it is appreciated that the PoE emulating device may be integrated within the non-PoE device.

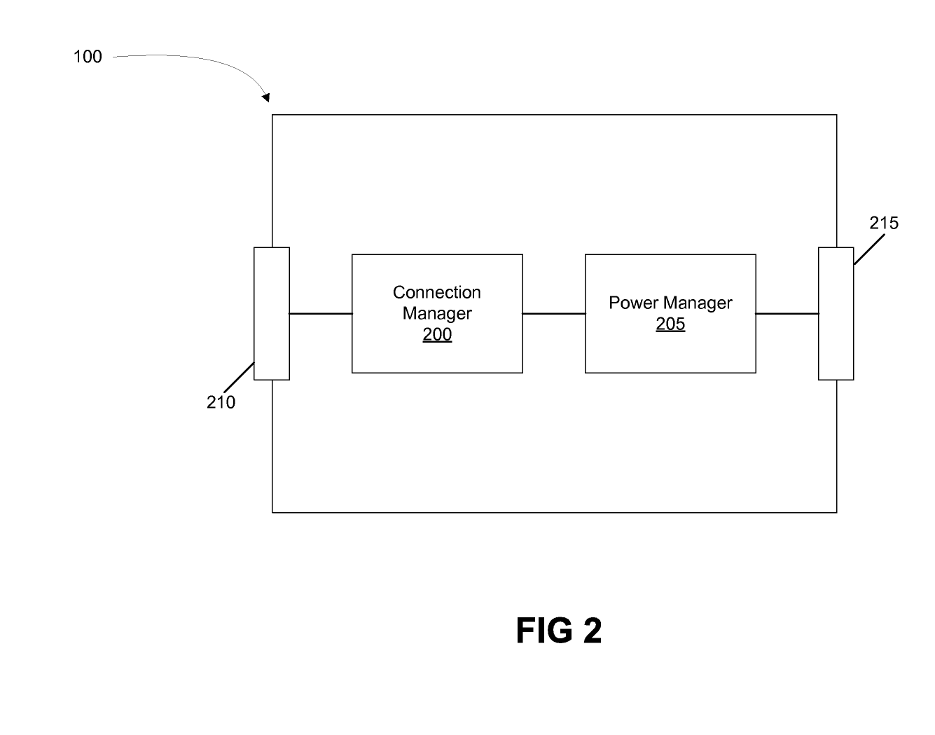

Referring now to FIG. 2, an architectural block diagram of PoE emulating device 100 for charging non-PoE devices is shown in accordance with some embodiments. As illustrated, PoE emulating device 100 includes connection manager module 200, power manager module 205, power receiving interface 210, and power provisioning interface 215.

In some embodiments, power receiving interface 210 is an interface (e.g., interface 125) through which connection manager module 200 receives power from a power sourcing PoE device (e.g., power sourcing PoE device 105). It is appreciated that power receiving interface 210 may be any type of interface (e.g., an Ethernet interface) that allows PoE emulating device 100 to draw power from a power sourcing PoE device. In some embodiments, power provisioning interface 215 is an interface (e.g., interface 135) through which power manager module 205 provides power to a non-PoE device (e.g., non-PoE device 110). It is appreciated that power provisioning interface 215 may be any type of interface (e.g., a USB interface) that allows PoE emulating device 100 to provide power to a non-PoE device.

Connection manager module 200 is configured to manage connections with a power sourcing PoE device through power receiving interface 210. For example, in some embodiments, connection manager module 200 establishes a PoE link with the power sourcing PoE device, performs functions to maintain the PoE link (e.g., drawing 5-10 milliamps (mA) for at least 60 milliseconds (ms) from the power sourcing PoE device, preventing the PoE link from idling (e.g., not drawing power) for more than 400 ms, etc.), and sends power from the power sourcing PoE device to power manager module 205. In some embodiments, connection manager module 200 is configured to establish a data connection with a power sourcing PoE device for transmitting data to other devices communicatively coupled to the power sourcing PoE device. In other embodiments, connection manager module 200 does not have the capability to establish a data connection with a power sourcing PoE device for transmitting data to other devices communicatively coupled to the power sourcing PoE device. That is, in such other embodiments, PoE emulating device 100 facilitates the provisioning of power, and not data communication, to non-PoE devices.

Power manager module 205 is configured to manage aspects of power that power manager module 205 receives from connection manager module 200. In some embodiments, power manager module 205 converts the voltage of the power from connection manager module 200 to a different voltage. For instance, power received from connection manager module 200, which was received from a power sourcing PoE device may, have a voltage ranging between 37 volts and 57 volts. The power manager module 205 may convert the received voltage ranging from 37 volts to 57 volts to another voltage (e.g., 5 volts, 12 volts, etc.) or a voltage range. It is appreciated that power manager module 205 may perform any number of different functions to control, maintain, regulate, modify, etc., characteristics of power (e.g., voltage, current, etc.) received from connection manager module 200. Power manager module 205 sends the managed power to a non-PoE device through power provisioning interface 215.

It is appreciated that the modules described above by reference to FIG. 2 may be implemented as circuitry, software for controlling circuitry, a combination of circuitry and software for controlling circuitry, etc. In addition, it is appreciated that PoE emulating device 100 may perform additional and/or different functions that are implemented by some or all of the modules illustrated in FIG. 2 and/or different modules. For instance, in some embodiments, PoE emulating device 100 performs functions required for interoperability with a power sourcing PoE device (e.g., an 802.3af, 802.3at, etc., compliant PSE).

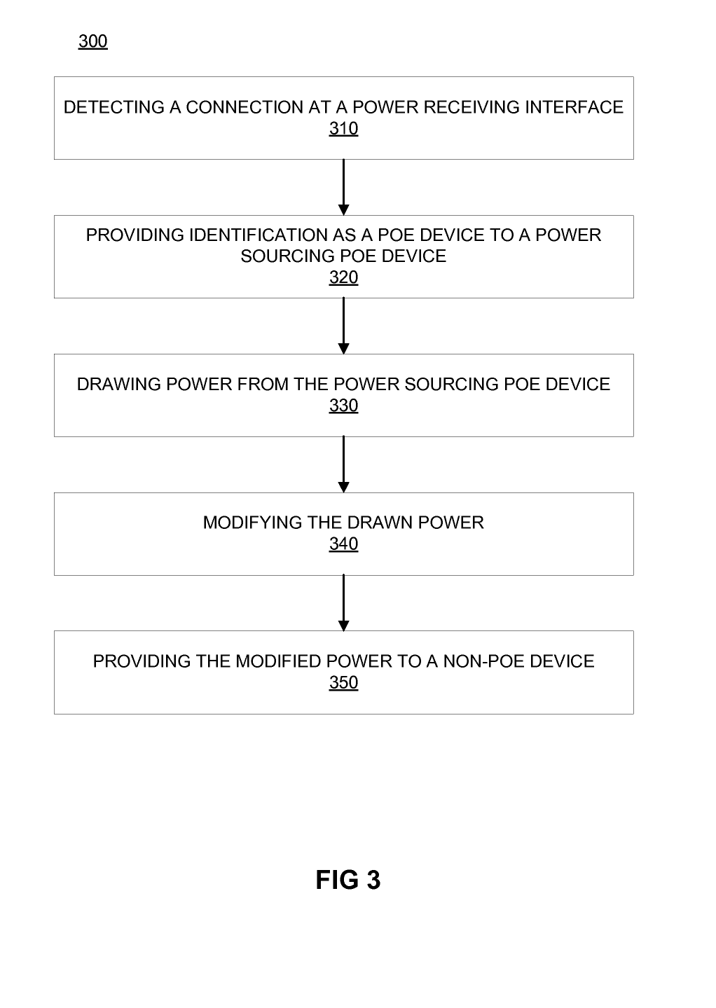

FIG. 3 shows an exemplary flow diagram for providing power to a non-PoE device in accordance with some embodiments. In some embodiments, a device (e.g., PoE emulating device 100) communicatively coupled to a power sourcing PoE device and a non-PoE device performs the operations described in FIG. 3. At step 310, a connection at a power receiving interface (e.g., the power receiving interface 210) is detected. It is appreciated that, in some embodiments, the power receiving interface is an Ethernet interface. In some such embodiments, the connection at the Ethernet interface is detected when an Ethernet cable attached to a power sourcing PoE device is connected to the Ethernet interface.

At step 320, identification as a PoE device is provided to a power sourcing PoE device. The identification is provided to the power sourcing PoE device in order to establish a PoE connection with the power sourcing PoE device. In some embodiments, identification is provided by applying a resistance (e.g., 25 kilo ohms across transmit and receive pairs of an Ethernet interface), which may be predetermined, at a power receiving interface (e.g., power receiving interface 210). It is appreciated that identification may be provided to a power sourcing PoE device in any number of different ways.

At step 330, power is drawn from the power sourcing PoE device. In some embodiments, 5-10 mA of power is drawn from the power sourcing PoE device. To maintain the PoE connection with the power sourcing PoE device, 5-10 mA of power is drawn from the power sourcing PoE device for at least 60 ms and the PoE link is prevented from idling for more than 400 ms.

After power is drawn from the power sourcing PoE device, the drawn power is modified at step 340. In some embodiments, the drawn power is modified by converting the voltage of the drawn power (e.g., 48 volts) to a different voltage (e.g., 5 volts, 12 volts, etc.). At step 350, the modified power is provided to a non-PoE device (e.g., for the non-PoE device to power the non-PoE device and/or charge batteries of the non-PoE device). It is appreciated that the drawn power may be modified based on requirements of the non-PoE device. For instance, if the non-PoE device requires power with a voltage of 5 volts and a current of 500 mA, the drawn power is modified according to such requirement.

The foregoing description, for purpose of explanation, has been described with reference to specific embodiments. However, the illustrative discussions above are not intended to be exhaustive or to limit the embodiments disclosed. Many modifications and variations are possible in view of the above teachings.

What is claimed is:

1. A device comprising:
a connection manager module configured to establish a connection with a power sourcing power over Ethernet (PoE) device, wherein the connection manager module is further configured to draw power from the power sourcing PoE device over the connection; and
a power manager module configured to modify the power drawn from the power sourcing PoE device, wherein the power manager module is further configured to provide the modified power to a non-PoE device.

2. The device as described in claim 1, further comprising an Ethernet interface through which the connection manager establishes the connection with the power sourcing PoE device and draws power from the power sourcing PoE device.

3. The device as described in claim 1, further comprising a power provisioning interface through which the power manager provides the modified power to the non-PoE device.

4. The device as described in claim 3, wherein the power provisioning interface is a universal serial bus (USB) interface.

5. The device as described in claim 1, wherein the connection manager module is further configured to provide to the power sourcing PoE device identification information that identifies the device as a PoE-capable device.

6. The device as described in claim 1, wherein the power manager module is further configured to convert the power from a first voltage to a second voltage.

7. The device as described in claim 1, wherein the non-PoE device is a mobile device.

8. A machine-readable storage medium having stored thereon, machine executable instructions that, if executed by a device, cause the device to perform a method comprising:
drawing power from a power sourcing power over Ethernet (PoE) device over a connection;
modifying the power drawn from the power sourcing PoE device; and
providing the modified power to a non-PoE device.

9. The machine-readable storage medium as described in claim 8, wherein the modified power powers the non-PoE device.

10. The machine-readable storage medium as described in claim 8, wherein the modified power charges a battery of the non-PoE device.

11. The machine-readable storage medium as described in claim 8, wherein the drawing of the power is via an Ethernet interface.

12. The machine-readable storage medium as described in claim 11, wherein the method further comprises providing identification information that identifies the device as a PoE-capable device to the power sourcing PoE device.

13. The machine-readable storage medium as described in claim 12, wherein the providing comprises applying a predetermined resistance across transmit and receive pairs of the Ethernet interface.

14. The machine-readable storage medium as described in claim 12, wherein the connection with the power sourcing PoE device is established in response to the providing the identification information to the power sourcing PoE device.

15. A method comprising:
drawing power from a power sourcing power over Ethernet (PoE) device over a connection;
modifying the power drawn from the power sourcing PoE device; and
providing the modified power to a non-PoE device.

16. The method as described in claim 15, wherein the modifying of the power drawn from the power sourcing PoE device comprises converting the power from a first voltage to a second voltage.

17. The method as described in claim 15, wherein the second voltage is 5 volts.

18. The method as described in claim 15, wherein the second voltage is 12 volts.

19. The method as described in claim 15, wherein the providing of the modified power to the non-PoE device comprises providing the modified power through a power receiving interface of the non-PoE device.

20. The method as described in claim 15, wherein the power receiving interface is a universal serial bus (USB) interface.
